(19) United States
(12) Patent Application Publication
(10) Pub. No.: US 2018/0374178 A1
(43) Pub. Date: Dec. 27, 2018

(54) Profiling Accountability Solution System

(71) Applicant: Bryan Selzer, Jacksonville, FL (US)

(72) Inventor: Bryan Selzer, Jacksonville, FL (US)

(21) Appl. No.: 16/016,027

(22) Filed: Jun. 22, 2018

Related U.S. Application Data
(60) Provisional application No. 62/523,628, filed on Jun. 22, 2017.

(51) Int. Cl. G06Q 50/26; G06Q 30/02; G06F 21/62; G06K 9/00

(52) U.S. Cl. CPC G06Q 50/265; G06Q 30/0205; G06K 9/00335; G06K 9/00711; G06F 21/6218

(57) ABSTRACT

This invention is for a software program that notifies a system administrator or other designated individual within a law enforcement department when an officer is employing disproportional enforcement in relation to the demographics of his or her patrol area. When notification is provided, the system allows the system administrator or other designated individual to review the officer's enforcement record for potential biases. It also allows the officer, system administrator, or other designated individual to explain the disproportional enforcement.

### BACKGROUND OF THE INVENTION

This invention relates to a software system that maintains accountability related to profiling within a law enforcement agency or department by utilizing demographic data within each patrol area of a law enforcement department and comparing it with an officer's citizen contact history. The need to encourage accountability and transparency of law enforcement departments' citizen interactions is growing. The present invention aims to hold officers accountable while also providing transparent and trackable information within the department. Officers in the United States are protectors of the public, aiming to help those in need and prevent harm to innocent members of society. As public perception of law enforcement departments is being challenged, it is important to provide statistical data on how a department or officer enforces laws based on the public's race, gender and age range.

### BRIEF SUMMARY OF THE INVENTION

The profiling accountability solution system is a web-based software application that monitors potential profiling by law enforcement departments and its employees. A software administrator creates patrol areas within the law enforcement department's jurisdiction. Once the patrol areas have been created, the administrator will identify and input the demographical breakdown of the population within each patrol area by age, gender and race. Officers of the department are then assigned to those patrol areas. The software system monitors the age, gender, and race of the citizens that an officer made contact with, which is to be referred to as civilian contact data. When the civilian contact data is entered into the system, the software compares the contact data of the officer with the population demographics of his assigned patrol area that was entered by the administrator.

The software administrator also sets threshold parameters of what percentage point(s) an officer's citizen contact enforcement has to exceed the population's demographics, based on the officer's assigned patrol area. Relative to the preset parameters, if the officer makes excessive contact with civilians of a certain race, age or gender, then the software will notify the officer's supervisor that the officer may potentially have a bias in how she or he enforces the law. Once the superior is aware of an officer's potential biased behavior, the superior can review the officer's civilian contact data and take appropriate action.

### BRIEF DESCRIPTION OF THE DRAWINGS

FIG. 1 is a flow chart that shows the roles of the system administrator.

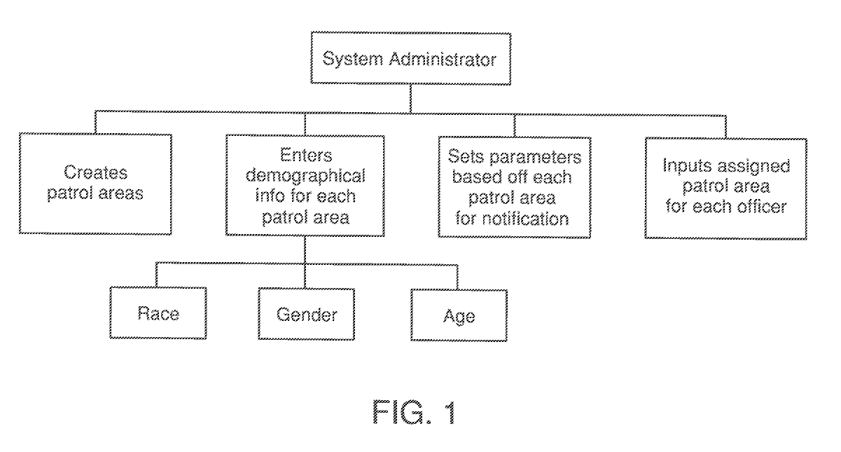

FIG. 2 is a flow chart that shows how an officer will use the software system.

FIG. 3 is a flow chart that shows when and how an officer's actions would be reported by the software system to a system administrator or other designated individual for review.

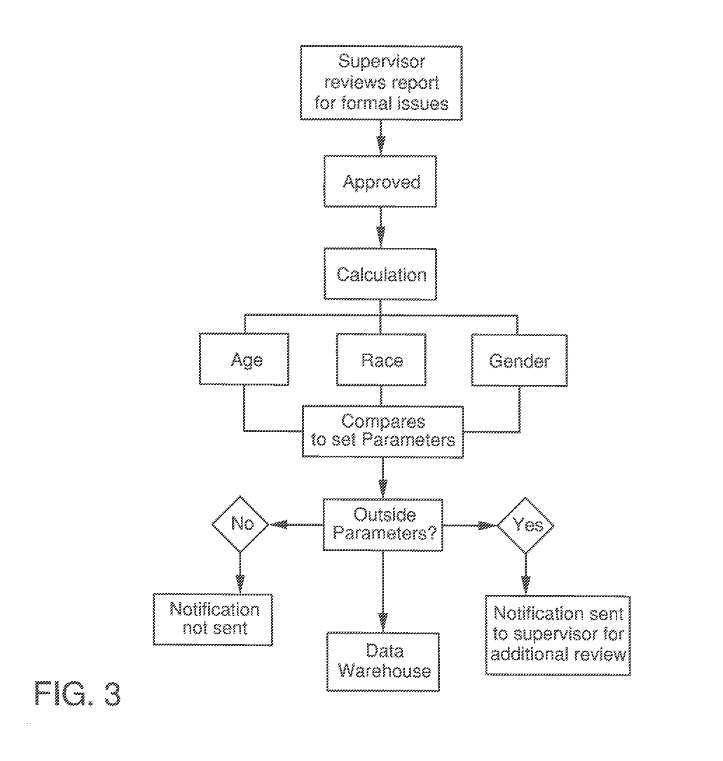

FIG. 4 is a chart illustrating when the system may indicate that an officer may have a bias.

FIG. 5 is a flow chart that shows when and how an officer's actions would be reported by the software system to a system administrator or other designated individual for review.

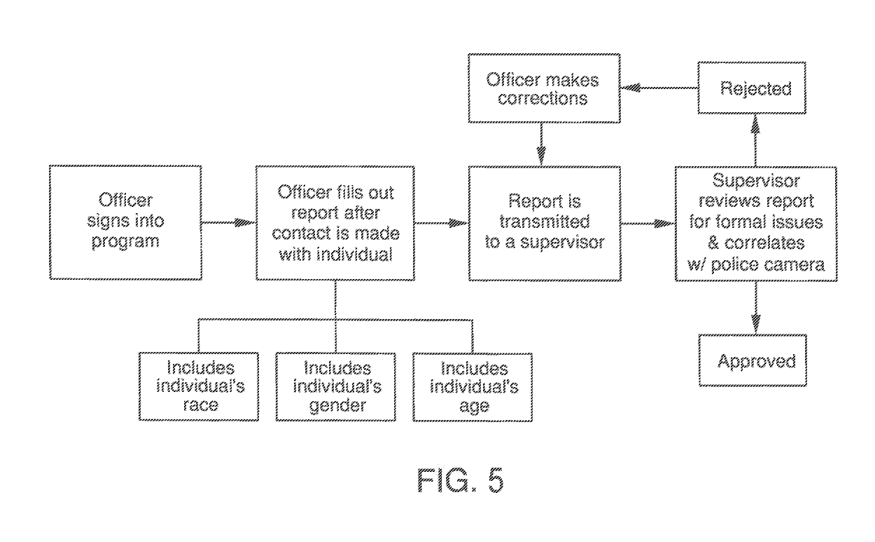

### DETAILED DESCRIPTION OF THE EMBODIMENTS

This invention described herein provides accountability of police enforcement by tracking an officer's contact with the general public and correlating it with the population demographics of his assigned patrol area(s). This is accomplished with the unique and novel software system described herein. The software system is comprised of a web based software application that may be accessed by a plurality of officers and supervisors. The software will require a system administrator. The system administrator may be a supervisor in the law enforcement department. With the present invention, the system administrator creates officer patrol areas within the department's jurisdiction, enters demographical characteristics for each patrol area, sets demographic threshold percentages, herein also referred to as parameters, for each patrol area, and assigns one or more officers to each patrol area.

The demographical characteristics entered by the system administrator includes, but is not limited to, the race, gender, and age of the general public in each patrol area. The system administrator or designated supervisor will also determine whether an officer takes different enforcement actions based on race, gender or age.

An officer will initially log into the software system and verify his or her assigned patrol area. When the officer makes contact with a civilian, he or she will fill out a civilian contact report after contact is made. The report is filled out within the web-based software system. It is anticipated that the officer would fill out the civilian contact report at the officer's computer in the officer's patrol vehicle. The report will require information about the individual's race, gender, and age, but allows for much more additional data such as gang membership, vehicle operated, employment and contact information. It is also anticipated that the officer may attached one or more digital images and one or more digital videos to the civilian contact form.

Once the law enforcement officer finishes his or her civilian contact report, it should be sent to a supervisor or other individual chosen by the law enforcement officer. If the report is missing necessary information or requires clarification, it is rejected and returned to the law enforcement officer for completion. If the civilian contact report is approved, the program saves the entered civilian contact data from the report. In particular, the system will at least save the age, race, and gender of civilians contacted by the law enforcement officer on a remote network server.

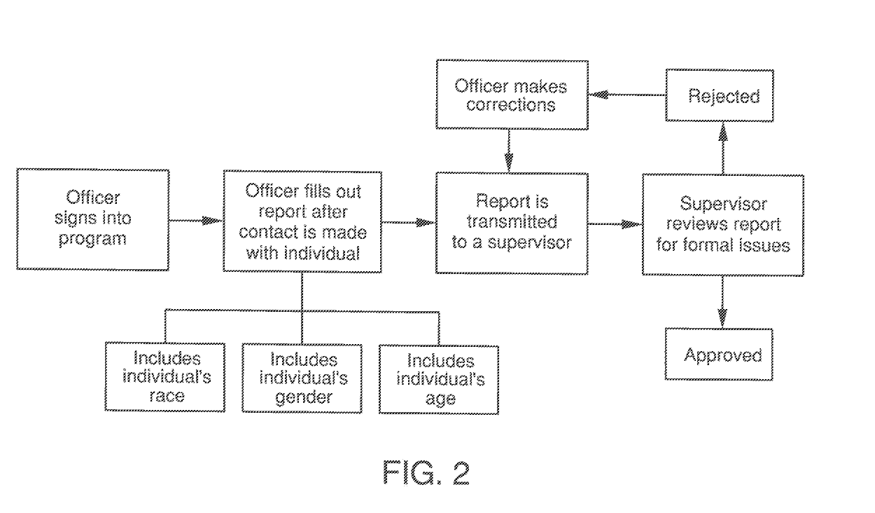

That civilian contact data is then used and compared to the demographic threshold set by the system administrator, which is referred to as the “calculation” shown in FIG. 2. If an officer has made excessive contact, relative to the demographic threshold, with individuals of the same race, gender, or age, the system will transmit a notification to the system administrator or another individual designated by the system administrator.

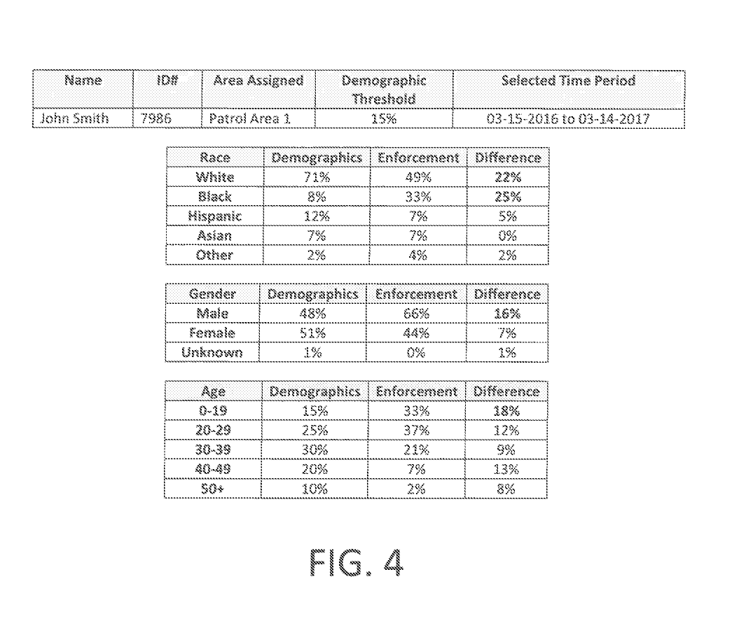

FIG. 4 provides an example of circumstances under which the present invention will operate. In the example, John Smith is a law enforcement officer and is assigned to patrol area one. The system administrator has assigned a demographic threshold of 15% for a selected time period. The demographic threshold is a tolerance level for the officer's enforcement as it relates to the demographics of the officer's patrol area. While in FIG. 4 the time period is one year, it is anticipated that the time period can be adjusted and the age can be set as age ranges. The example in FIG. 4 shows three separate charts: one chart for race, one chart for gender, and one chart for age.

The first chart examines the officer's contact respective to race; it shows that his patrol area is 71% White, 8% Black, 12% Hispanic, 7% Asian, and 2% other. Then for each race, the officer's enforcement is 49%, 33%, 7%, 7%, and 4% respectively. The system determines the difference between enforcement and patrol area demographics. The difference between the racial demographic of the patrol area and the officer's enforcement is 22% for white individuals, 25% for black individuals, 5% for Hispanics, 0% for Asian, and 2% for others.

Since the enforcement on black individuals is excessively high relative to the black population in the officer's patrol area and above the demographic threshold set by the system administrator, the officer's conduct will be flagged for review by the officer's supervisor. Similarly, since the officer's enforcement on white individuals was excessively low relative to the white population in the officer's patrol area and is above the demographic threshold set by the system administrator, the officer's conduct will be flagged for review by the officer's supervisor. In both instances, the system will additionally notify the officer's supervisor or other designated individual so appropriate action can be taken.

The second chart relates to the officer's contact respective to gender. In FIG. 4 it shows that the male demographics in the officer's patrol area is 48%. FIG. 4 additionally shows that the officer's contact or enforcement takes place with males 66% of the time over the specified time period. Because the difference between the officer's enforcement on males is greater than the demographic threshold of 15%, the officer's conduct will be flagged for review and the officer's supervisor will be notified by the system.

The third chart relates to age brackets. Accordingly, the officer's conduct would be flagged for review as it relates to age discrimination because there is an 18% difference between the 0-19 year-old demographic and the percentage of the officer's enforcement. The officer's supervisor would be notified in this case as well.

It is anticipated that an officer is likely to be assigned to various patrol areas over a long period of time. Accordingly, over the predesignated period of time, the system dynamically takes into account the demographics of each patrol area in which the officer patrolled. Also, the system can have additional demographic thresholds. For example, if an officer exceeds a 75% demographic threshold over a short period of time that is less than one year, then the officer's supervisor or other individual would be notified.

It is critical that when an officer has exceeded the demographic threshold a review is made prior to taking negative action against an officer. For example, if an officer is on call during a protest or rally that turns violent, the officer's civilian contact data could be skewed. The system or the officer's supervisor can take such events into account when determining if an officer has exceeded the designated demographic threshold.

While the embodiments of the invention have been disclosed, certain modifications may be made by those skilled in the art to modify the invention without departing from the spirit of the invention.

The inventor claims:

1. Profiling accountability software system for correlating officer civilian contact with demographics of the officer's patrol area to recognize officer enforcement bias, which is comprised of:
a. a web-based software further comprising;
i. an administrator profile;
wherein at least one system administrator profile is provided;
wherein only a system administrator may access the at least one system administrator profile;
wherein the system administrator creates a plurality of geographical patrol areas within the web-based software;
wherein at least one officer is assigned to each geographical patrol area;
wherein the system administrator enters respective demographical characteristic for each geographical patrol area within the plurality of geographical patrol areas;
wherein the system administrator sets racial bias parameters for the plurality of geographical patrol areas;
ii. a plurality of officer profiles;
wherein the plurality of officer profiles is provided by the system administrator;
wherein only an officer or system administrator may access an officer profile within the plurality of officer profiles;
iii. a civilian contact form;
wherein the civilian contact form is accessible in the plurality of officer profiles;
wherein the civilian contact form requires that civilian contact data be entered into the civilian contact form;
wherein the civilian contact form can be submitted to at least one supervisor of the officer once the civilian contact data is entered into the civilian contact form;
iv. a supervisor profile;
wherein a supervisor profile is provided by the system administrator;
wherein only a supervisor or system administrator may access the supervisor profile;
wherein the submitted civilian contact form can be accessed through the supervisor profile;
wherein the supervisor may accept or reject the submitted civilian contact report;
wherein the software correlates officer civilian contact with civilian demographic characteristics of the assigned officer patrol area;
wherein the supervisor profile provides a notification if officer civilian contact with individuals of a specific demographical characteristic exceeds the racial bias parameters.

2. The profiling accountability software system of claim 1 wherein video capturing equipment is provided.

3. The profiling accountability software system of claim 2 wherein the video capturing equipment captures images of civilians contacted by an officer.

4. The profiling accountability software system of claim 2 wherein the video capturing equipment captures videos of civilians contacted by an officer.

5. The profiling accountability software system of claim 1 wherein at least one digital video may be attached to the civilian contact form.

6. The profiling accountability software system of claim 1 wherein the civilian contact data is comprised of race, gender, and age of a contacted civilian.

7. The profiling accountability software system of claim 6 gang membership and civilian vehicle operated at time of contact.

8. The profiling accountability software system of claim 1 wherein at least one digital image may be attached to the civilian contact form.

9. The profiling accountability software system for correlating officer civilian contact with demographics of the officer's patrol area to recognize officer enforcement bias, which is comprised of:
a. video capturing equipment;
wherein the video capturing equipment captures images of civilians contacted by an officer;
wherein the video capturing equipment captures video of civilians contact by an officer;
b. a web-based software further comprising;
i. an administrator profile;
wherein at least one system administrator profile
wherein only a system administrator may access the at least one system administrator profile;
wherein the system administrator creates a plurality of geographical patrol areas within the web-based software;
wherein at least one officer is assigned to each geographical patrol area;
wherein the system administrator enters respective demographical characteristic for each geographical patrol area within the plurality of geographical patrol areas;
wherein the system administrator sets racial bias parameters for the plurality of geographical patrol areas;
ii. a plurality of officer profiles;
wherein the plurality of officer profiles is provided by the system administrator;
wherein only an officer or system administrator may access an officer profile within the plurality of officer profiles;
iii. a civilian contact form;
wherein the civilian contact form is accessible in the plurality of officer profiles;
wherein the civilian contact form requires that civilian contact data be entered into the civilian contact form;
wherein the civilian contact form can be submitted to at least one supervisor of the officer once the civilian contact data is entered into the civilian contact form;
wherein at least one digital image is attached to the digital contact form;
wherein at least one digital video is attached to the digital contact form;
iv. a supervisor profile;
wherein a supervisor profile is provided by the system administrator;
wherein only a supervisor or system administrator may access the supervisor profile;
wherein the at least one supervisor may access a submitted civilian contact form through the supervisor profile;
wherein the supervisor may accept or reject the submitted civilian contact report;
wherein the software correlates officer civilian contact with civilian demographic characteristics of the assigned officer patrol area;
wherein the supervisor profile provides a notification if officer civilian contact with individuals of a specific demographical characteristic exceeds the racial bias parameters.

10. The profiling accountability software system of claim 9 wherein the civilian contact data is comprised of race, gender, and age.

11. The profiling accountability software system of claim 10 wherein the civilian contact data is further comprised of gang membership, and vehicle operated at time of officer contact.
